(19) United States
(12) Patent Application Publication
(10) Pub. No.: US 2020/0363990 A1
(43) Pub. Date: Nov. 19, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/592,854

(22) Filed: Oct. 4, 2019

(30) Foreign Application Priority Data
May 16, 2019 (JP) 2019-093014

(51) Int. Cl. G06F 3/06

(52) U.S. Cl. CPC G06F 3/0659; G06F 3/0673; G06F 3/0653; G06F 3/0604

(57) ABSTRACT

An information processing apparatus includes a management unit that manages a stored work in a storage unit and a created date of the stored work in the storage unit and a determination unit that determines, in response to an attempt to store a first work into the storage unit, whether to allow the first work to be stored into the storage unit on a basis of comparison between a content of the stored work and a content of the first work and comparison between the created date of the stored work and a created date of the first work.

### CROSS-REFERENCE TO RELATED APPLICATIONS

This application is based on and claims priority under 35 USC 119 from Japanese Patent Application No. 2019-093014 filed May 16, 2019.

### BACKGROUND

### (i) Technical Field

The present disclosure relates to an information processing apparatus and a non-transitory computer readable medium.

### (ii) Related Art

Works may sometimes be stored in a storage unit, such as a server.

Japanese Unexamined Patent Application Publication No. 2009-217661 describes a system that extracts content that is to be determined whether it infringes copyright.

Japanese Unexamined Patent Application Publication No. 2002-366531 describes a system that checks if the content on a web page viewed by a user infringes copyright and that informs a server of copyright infringement found by the system.

Japanese Unexamined Patent Application Publication No. 2003-30359 describes an apparatus that provides notification to a notification destination when it is detected that copyright information is embedded in content.

Japanese Unexamined Patent Application Publication No. 2008-217572 describes an apparatus that extracts characteristic data from a copyright-confirmation-target content and determines that the copyright-confirmation-target content is not transferable when content that has the same characteristic is detected.

### SUMMARY

Aspects of non-limiting embodiments of the present disclosure relate to suppressing or preventing a work from being illegally stored into a storage unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a management unit that manages a stored work in a storage unit and a created date of the stored work in the storage unit and a determination unit that determines, in response to an attempt to store a first work into the storage unit, whether to allow the first work to be stored into the storage unit on a basis of comparison between a content of the stored work and a content of the first work and comparison between the created date of the stored work and a created date of the first work.

### BRIEF DESCRIPTION OF THE DRAWINGS

An exemplary embodiment of the present disclosure will be described in detail based on the following figures, wherein:

FIG. 1 is a block diagram illustrating a configuration of an information processing system according to the exemplary embodiment;

FIG. 2 is a block diagram illustrating a configuration of an information processing apparatus according to the exemplary embodiment;

FIG. 3 is a block diagram illustrating a configuration of a terminal apparatus;

FIG. 4 is a diagram illustrating a management table;

FIG. 5 is a diagram illustrating a screen; and

FIG. 6 is a diagram illustrating another screen.

### DETAILED DESCRIPTION

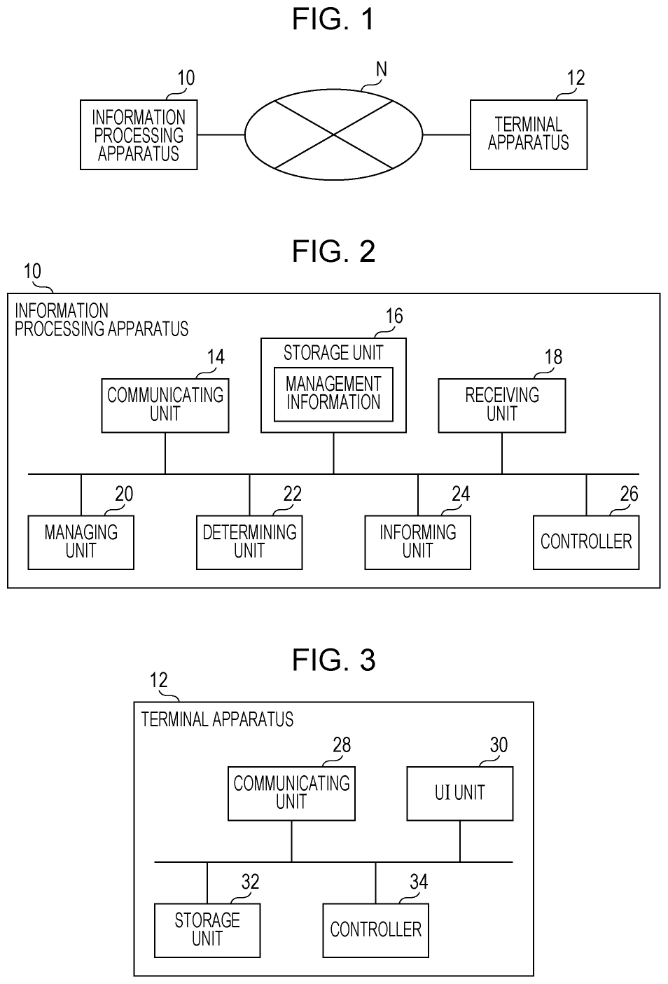

An information processing system according to an exemplary embodiment of the present disclosure will be described below with reference to FIG. 1. FIG. 1 illustrates an example of the configuration of the information processing system according to the present exemplary embodiment.

The information processing system according to the present exemplary embodiment includes an information processing apparatus 10 and at least one terminal apparatus 12. The information processing system may include an apparatus other than these apparatuses.

The information processing apparatus 10 and the terminal apparatus 12 may communicate with other devices via a communication path N. For example, the communication path N is a network such as a local area network (LAN), the Internet, or the like. The communication path N may be constructed by wired communication or may be constructed by wireless communication such as Wi-Fi (registered trademark). For example, the information processing apparatus 10 and the terminal apparatus 12 are connected to the communication path N by using wireless communication or wired communication and communicate with other devices via the communication path N. The information processing apparatus 10 and the terminal apparatus 12 may communicate with other devices by short-range wireless communication or the like without using the communication path N. The short-range wireless communication is, for example, the Bluetooth (Registered Trademark), radio-frequency identification (RFID), near field communication (NFC), or the like.

The information processing apparatus 10 is an apparatus that manages attribute information of works stored in a work storage unit, and when a work that is to be newly managed (hereinafter referred to as a “first work”) is attempted to be stored into the work storage unit, the information processing apparatus 10 determines whether to permit the first work to be stored into the work storage unit. The work storage unit includes one or more storage devices (e.g., physical drives such as hard disk drives or memories). The work storage unit may be provided in the information processing apparatus 10 or may be provided in a device such as a server. For example, when first work data is attempted to be uploaded to the work storage unit, the information processing apparatus 10 determines whether to permit this first work data to be uploaded to the work storage unit. Note that the information processing apparatus 10 may be a server.

Examples of works include, but are not limited to, documents (e.g., texts), images (e.g., still images or moving images), musical works, audio works, or combinations of these. The term “Works” according to the present exemplary embodiment may include works that are mentioned as subject matter of copyright in copyright laws. More specific examples of “works” include, but are not limited to, language works (e.g., novels, screenplays, and papers), music works, choreography works, art works (e.g., paintings, prints, sculptures, and artworks), architectural works, graphic works (e.g., maps and drawings), movie works (e.g., movies, TV shows, and video games), photograph works, program works, and derivative works of these works.

Attribute information of a work is information that is associated with the work and that indicates an attribute of the work. Attribute information includes at least (1) content information that indicates the content of the work data and (2) created-date information that indicates a created date, which is the date on which the work data is created. The content of the work data may be a characteristic of the work data, or an overview of the work data. The created date is the date on which the work data is created. The created-date information may be information that indicates a created date and time, which is the date and time when the work data is created. The attribute information may further include title information that indicates the title of the work data, updated-date information that indicates an updated date, which is the date on which the work data is updated, author information that indicates the name of an author, and so forth. The updated-date information may be information that indicates an updated date and time, which is the date and time when the work data is updated. Obviously, the attribute information may include information items other than these information items (e.g., information that indicates the copyright holder and so forth). Instead of using the attribute information including the content information, the work data itself may be used as content information.

When work data is data that represents the original work of a non-electronic work (e.g., document data or image data), information that indicates an original-work created date, which is the date on which the original work is created, information that indicates an original-work created date and time, which is the date and time when the original work is created, and author information that indicates the name of the author of the original work may also be included in the attribute information. A non-electronic work is a work that has not been converted to an electronic format (i.e., that has not been digitized). For example, when image data representing a book that is an original work and that has not been converted into an electronic format is created as work data, the attribute information of the work data includes information that indicates the original-work created date and the original-work created date and time of the book, information that indicates the created date and the created date and time of the image data representing the book, and author information that indicates the author of the book. For example, when the image data representing the book is created as the work data by scanning the book that has not been converted into an electronic format, the created date described in the book is used as the original-work created date, and the date on which the work data is created is used as the created date of the work data. Note that, the information that represents the created date described in the book may be obtained by scanning the book and may be included in the attribute information.

The terminal apparatus 12 is an apparatus that is used when work data is stored into the work storage unit. As an example, the terminal apparatus 12 is a personal computer (hereinafter referred to as “PC”), a tablet PC, a smartphone, a cellular phone, or another apparatus (e.g., a multifunction machine that includes a scanner, a printer, and so forth). Obviously, these apparatuses are merely examples of the terminal apparatus 12. For example, the terminal apparatus 12 is used when work data is uploaded. Note that the work data stored in the work storage unit may be used by the terminal apparatus 12 or may be used by a device other than the terminal apparatus 12.

The configuration of the information processing apparatus 10 will be described in detail below with reference to FIG. 2. FIG. 2 illustrates an example of the configuration of the information processing apparatus 10.

The communication unit 14 is a communication interface and has a function of transmitting information to other devices and a function of receiving information from other devices. The communication unit 14 may have a wireless communication function or may have a wired communication function. The communication unit 14 may communicate with other devices by using wireless communication or wired communication via the communication path N or may communicate with other devices by short-range wireless communication or the like without using the communication path N.

A storage unit 16 includes one or more storage areas that store various information items. Each of the storage areas is formed of, for example, the one or more storage devices (e.g., physical drives such as hard disk drives or memories) included in the information processing apparatus 10.

The storage unit 16 stores management information. The management information is information that is used for managing the attribute information of each work data stored in the work storage unit. For example, when work data is uploaded to the work storage unit, the attribute information of the uploaded work data is registered in the management information.

The work storage unit may be included in the storage unit 16. In this case, work data may be uploaded to the information processing apparatus 10 and may be stored into the work storage unit, which is included in the storage unit 16.

A receiving unit 18 is configured to receive the attribute information of work data. For example, when the attribute information of work data is transmitted from the terminal apparatus 12 to the information processing apparatus 10, the receiving unit 18 receives the attribute information.

The receiving unit 18 may receive work data. For example, in the case where an apparatus to which work data is to be uploaded is the information processing apparatus 10, when the work data is uploaded to the information processing apparatus 10, the receiving unit 18 receives the uploaded work data. The work data is stored into the work storage unit, which is included in the storage unit 16.

A managing unit 20 is configured to manage the attribute information of each work data stored in the work storage unit. More specifically, the managing unit 20 registers the attribute information of each of the work data items that are stored in the work storage unit into the management information, which is stored in the storage unit 16. In other words, when work data is uploaded to the work storage unit, the managing unit 20 registers the attribute information of the uploaded work data into the management information.

When data of a first work that is a work to be newly managed by the managing unit 20 is attempted to be stored into the work storage unit, a determining unit 22 determines whether to permit the first work data to be stored into the work storage unit on the basis of the attribute information of each work data that has been already stored in the work storage unit and the attribute information of the first work data. As described above, since the attribute information of each work data stored in the work storage unit is registered in the management information, the determining unit 22 determines whether to permit the first work data to be stored into the work storage unit by referencing to the management information.

Information that indicates a determination result obtained by the determining unit 22 is transmitted from the information processing apparatus 10 to the terminal apparatus 12 that is used by a user who attempts to store the first work data into the work storage unit. Then, the information indicating the determination result is displayed on the terminal apparatus 12.

For example, in the case where no work data that has content the same as the content of the first work is stored in the work storage unit, the determining unit 22 permits the first work data to be stored into the work storage unit. For example, the determining unit 22 permits the first work data to be uploaded. In the case where no work data that has content the same as the content of the first work data is stored in the work storage unit, it is presumed that the first work data is original. In other words, the determining unit 22 determines that the first work data is original. Original work data is data of a work created before data of other works that have content substantially the same as the content of the original work data is created. Information that indicates that the first work data is permitted to be stored into the work storage unit is transmitted from the information processing apparatus 10 to the terminal apparatus 12 and displayed on the terminal apparatus 12.

When work data items each of which has content the same as the content of work data that is a new management target have already been stored in the work storage unit, the determining unit 22 determines one of the stored work data items that has been created on the earliest date to be original. In other words, the one of the stored work data items that has been created on the earliest date is presumed to be the work data item that has been created first, and the other work data items each of which has been created on a later date is presumed to be the work data items that have been created afterwards.

In the case where another work data that has content substantially the same as the content of the first work data has already been stored in the work storage unit, when the created date of the first work data is earlier than the created date of the other work data, the determining unit 22 permits the first work data, to be stored into the work storage unit. In other words, the first work data is presumed to be the original work data, and thus, the determining unit 22 permits the first work data to be stored into the work storage unit.

In the case where another work data that has content substantially the same as the context of the first work data has already been stored in the work storage unit, when the created date of the first work data is later than the created date of the other work data, the determining unit 22 does not permit the first work data to be stored into the work storage unit. In other words, the first work data is presumed not to be the original work data, and thus, the determining unit 22 does not permit the first work data to be stored into the work storage unit. Information that indicates that the work data is not permitted to be stored in the work storage unit is transmitted from the information processing apparatus 10 to the terminal apparatus 12 and displayed on the terminal apparatus 12.

In the case where another work data that has content substantially the same as the content of the first work data has already been stored in the work storage unit, when the created date of the first work data is substantially the same as the created date of the other work data, the determining unit 22 may not permit the first work data to be stored into the work storage unit or may permit the first work data to be stored into the work storage unit. Granting or not granting of the permission may be set by a user, an administrator, or the like. The determining unit 22 may compare the created date and times of these work data items and may determine that one of these work data items whose created date and time is earlier than the other is the original work data. In this case, when the created date and time of the first work data is earlier than the created date and time of the other work data, the determining unit 22 permits the first work data to be stored into the work storage unit. When the created date and time of the first work data is later than the created date and time of the other work data, the determining unit 22 does not permit the first work data to be stored into the work storage unit. When the created date and times of these work data items are substantially the same as each other, the determining unit 22 may not permit the first work data to be stored into the work storage unit or may permit the first work data to be stored into the work storage unit. Granting or not granting of the permission may be set by a user, an administrator, or the like.

In the case where no work data that has content substantially the same as or similar to the content of the first work data is stored in the work storage unit, the determining unit 22 may permit the first work data to be stored into the work storage unit. In other words, in the case where no other work data that is within a similarity range of the content of the first work data is not stored in the work storage unit, the determining unit 22 permits the first work data to be stored into the work storage unit. For example, the determining unit 22 permits the first work data to be uploaded. In the case where no other work data that has content substantially the same as or similar to the content of the first work data is stored in the work storage unit, the first work data is presumed to be the original work data.

In the case where work data items each of which has content substantially the same as or similar to the content of the first work data, have already been stored in the work storage unit, the determining unit 22 determines one of the stored work data items that has been created on the earliest date to be the original work data.

When the content of one work data item and the content of another work data item are similar to each other, the degree of match between the contents of these work data items is equal to or greater than a predetermined threshold. For example, by comparing one work data item and another work data item in terms of, for example, elements such as title, text, figure, color, sound, and image that are included in these work data items, combinations of these elements, and relative relationships between the elements (e.g., positional relationship, magnitude relationship, color relationship, and the like), the degree of similarity between the work data items is calculated. When the degree of similarity is equal to or greater than a threshold, it is determined that the contents of these work data items are similar to each other. This processing may be performed by the determining unit 22 or may be performed by a device such as a server. Obviously, the degree of similarity may be determined by using a commonly known technology. For example, a commonly known algorithm for calculating the degree of similarity between images, documents, sounds, or the like may be used.

In the case where another work data that has content substantially the same as or similar to the content of the first work data has already been stored in the work storage unit, when the created date of the first work data is earlier than the created date of the other work data, the determining unit 22 permits the first work data to be stored into the work storage unit. In other words, the first work data is presumed to be the original work data, and thus, the determining unit 22 permits the first work data to be stored into the work storage unit.

In the case where another work data that has content substantially the same as or similar to the content of the first work data has already been stored in the work storage unit, when the created date of the first work data is later than the created date of the other work data, the determining unit 22 does not permit the first work data to be stored into the work storage unit. In other words, the first work data is presumed not to be the original work data, and thus, the determining unit 22 does not permit the first work data to be stored into the work storage unit.

In the case where another work data that has content substantially the same as or similar to the content of the first work data has already been stored in the work storage unit, when the created date of the first work data is substantially the same as the created date of the other work data, the determining unit 22 may not permit the first work data to be stored into the work storage unit or may permit the first work data to be stored into the work storage unit. Granting or not granting of the permission may be set by a user, an administrator, or the like. The determining unit 22 may compare the created date and times of these work data items and may determine that one of these work data items whose created date and time is earlier than the other is the original work data. In this case, when the created date and time of the first work data is earlier than the created date and time of the other work data, the determining unit 22 permits the first work data to be stored into the work storage unit. When the created date and time of the first work data is later than the created date and time of the other work data, the determining unit 22 does not permit the first work data to be stored into the work storage unit. When the created date and times of these work data items are substantially the same, the determining unit 22 may not permit the first work data to be stored into the work storage unit or may permit the first work data to be stored into the work storage unit. Granting or not granting of the permission may be set by a user, an administrator, or the like.

When the first work data is permitted to be stored into the work storage unit, and the first work data is transmitted to the work storage unit, the first work data is stored into the work storage unit. In other words, the work data that is presumed to be the original work data is stored into the work storage unit. The managing unit 20 registers the attribute information of the first work data into the management information. For example, a user who attempts to store the first work data into the work storage unit issues a storing instruction, the first work data is transmitted to and stored into the work storage unit. Even if a user who attempts to store the first work data into the work storage unit does not issue the storing instruction, the first work data may be transmitted to and stored into the work storage unit.

In the case where the created date or the created date and time of work data is unknown, the determining unit 22 may perform determination on the basis of the last updated date or the last updated date and time of the work data. Information items that indicate the updated date and the updated date and time are included in the attribute information of the work data.

When the content of work data is updated, the determining unit 22 makes an updated determination based on the updated content. For example, when the content of first work data is updated, the determining unit 22 changes a determination result depending on whether another work data that has content substantially the same as the updated content of the first work data has already been stored in the work storage unit. In the case where no work data that has content substantially the same as the updated content of the first work is stored in the work storage unit, the determining unit 22 permits the first work data to be stored into the work storage unit. In the case where another work data that has content substantially the same as the updated content of the first work has already been stored in the work storage unit, if the updated date of the first work data is earlier than the created date of the other work data, the determining unit 22 permits the first work data, which is the new management target, to be stored into the work storage unit. In the case where the content of the other work data is updated, if the updated date of the first work data is earlier than the updated date of the other work data, the determining unit 22 may permit the first work data to be stored into the work storage unit. When the updated date of the first work data is later than the created date of the other work data, the determining unit 22 does not permit the first work data to be stored into the work storage unit. When the updated date of the first work data is later than the updated date of the other work data, the determining unit 22 may not permit the first work data to be stored into the work storage unit. The determining unit 22 may change a determination result depending on whether work data that has content similar to the updated content of the first work data has already been stored in the work storage unit. Also in this case, processing that is the same as the above-described determination processing is performed.

Note that, when the author of the first work data is the same as the author of the above-mentioned other work data, the determining unit 22 may not perform the above-described determination. In this case, the determining unit 22 permits the first work data to be stored into the work storage unit.

In the case where another work data that has content the same as the content of the first work data has already been stored in the work storage unit, when the created date of the first work data is earlier than the created date of the other work data, an informing unit 24 informs at least a user who has stored the other work data into the work storage unit or an administrator of the situation. In the case where another work data that has content the same as or similar to the content of the first work data has already been stored in the work storage unit, when the created date of the first work data is earlier than the created date of the other work data, the informing unit 24 may inform at least one of the above-mentioned user and the above-mentioned administrator of the situation. For example, the informing unit 24 transmits information that indicates that the created date of the first work data is earlier than the created date of the other work data to the terminal apparatus 12 that is used by the user or the terminal apparatus 12 that is used by the administrator. In other words, when the first work data is presumed to be the original work data, the informing unit 24 informs accordingly.

When the author of the first work data is the same as the author of the above-mentioned other work data, the informing unit 24 may not perform the above informing processing.

A controller 26 is configured to control the operation of each unit of the information processing apparatus 10. For example, the controller 26 causes information that indicates a determination result obtained by the determining unit 22 to be displayed on the terminal apparatus 12 used by a user who attempts to store the first work data into the work storage unit. More specifically, the information indicating the determination result is transmitted from the information processing apparatus 10 to the terminal apparatus 12 under control of the controller 26 and displayed on the terminal apparatus 12.

In the case where another work data that has content the same as the content of the first work data has already been stored in the work storage unit, when the created date of the first work data is earlier than the created date of the other work data, the controller 26 may delete the other work data from the work storage unit. When a user who has stored the other work data into the work storage unit or an administrator issues a deletion instruction, the controller 26 may delete the other work data from the work storage unit. Obviously, the controller 26 may delete the other work data from the work storage unit without receiving a deletion instruction from a user or an administrator.

In the case where another work data that has content the same as or similar to the content of the first work data has already been stored in the work storage unit, when the created date of the first work data is earlier than the created date of the other work data, the controller 26 may delete the other work data from the work storage unit. The controller 26 may delete the other work data upon receiving a deletion instruction from a user or an administrator or may delete the other work data without receiving the instruction.

Note that when work data is deleted from the work storage unit, the managing unit 20 may not delete the attribute information of the deleted work data from the management information. In other words, even when work data that has been stored in the work storage unit in the past is deleted from the work storage unit, the managing unit 20 may not delete the attribute information of the work data from the management information. Not deleting the attribute information from the management information enables the determining unit 22 to determine whether to permit the first work data to be stored into the work storage unit while the work data that has been stored in the work storage unit in the past and then deleted from the work storage unit is also treated as a comparison target. Obviously, when work data is deleted from the work storage unit, the managing unit 20 may delete the attribute information of the deleted work data from the management information.

The configuration of the terminal apparatus 12 will be described in detail below with reference to FIG. 3. FIG. 3 illustrates an example of the configuration of the terminal apparatus 12. Here, as an example, the terminal apparatus 12 is a PC, a tablet PC, a smartphone, or a cellular phone.

A communicating unit 28 is a communication interface and has a function of transmitting information to other devices and a function of receiving information from other devices. The communicating unit 28 may have a wireless communication function or may have a wired communication function. The communicating unit 28 may communicate with other devices by using wireless communication or wired communication via the communication path N or may communicate with other devices by using short-range wireless communication or the like without using the communication path N.

A UI unit 30 is a user interface and includes a display unit and an operation unit. The display unit is a display device such as a liquid crystal display. The operation unit is an input device such as a keyboard, an input key, or an operation panel. The UI unit 30 may be a UI unit such as a touch panel that includes both a display unit and an operation unit.

A storage unit 32 includes one or more storage areas that store various information items. Each of the storage areas is formed of, for example, the one or more storage devices (e.g., physical drives such as hard disk drives or memories) included in the terminal apparatus 12.

A controller 34 is configured to control the operation of each unit of the terminal apparatus 12. For example, when information that indicates a determination result obtained by the determination unit 22 is transmitted from the information processing apparatus 10 to the terminal apparatus 12, the controller 34 causes the information indicating the determination result to be displayed on the display unit of the UI unit 30.

Note that the determination unit 22 may be included in the terminal apparatus 12. In this case, the processing that is to be performed by the determination unit 22 may be performed in the terminal apparatus 12.

The information processing system according to the present exemplary embodiment will be described in further detail below.

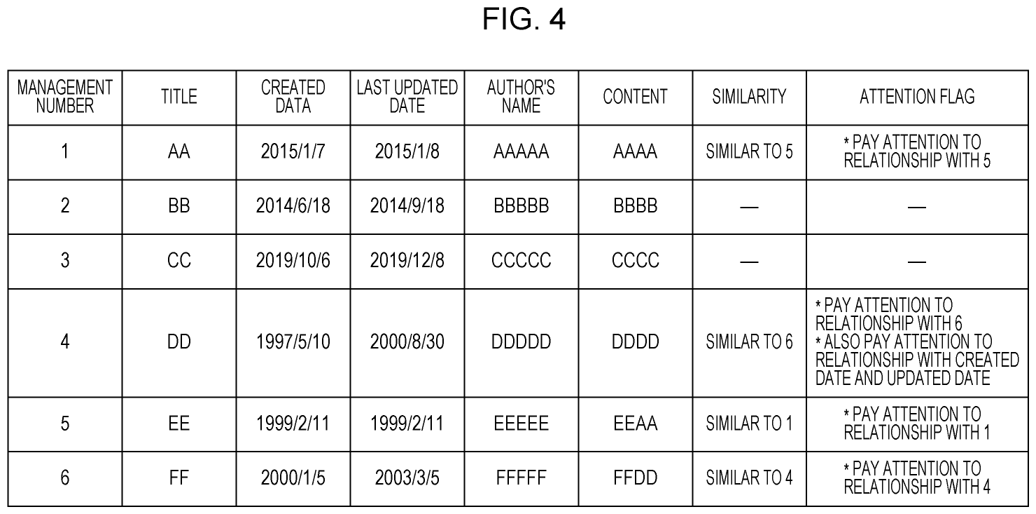

The management information will now be described in detail with reference to FIG. 4. FIG. 4 illustrates an example of a management table. The management table corresponds to an example of the management information and is a table that is used for managing the attribute information of each work data item. The management table is stored in the storage unit 16 of the information processing apparatus 10.

Here, as an example, the attribute information of a work data item includes a management number, title information, created-date information, updated-date information, author information, content information, similarity information, and attention-flag information. In the management table, as an example, a management number, title information, created-date information, updated-date information, author information, content information, similarity information, and attention-flag information are associated with one another for each work data item.

The title information is information that indicates the title of a work data item. The created-date information is information that indicates the created date of a work data item. Here, although a created date is used as an example, a created date and time may be used. The updated-date information is information that indicates the last updated date of a work data item. Here, although an updated date is used as an example, an updated date and time may be used. The author information is information that indicates the name of the author of a work data item. The content information is information that indicates the content of a work data item. The similarity information is information that indicates the similarity between a work data item and the other work data items registered in the management table. The attention-flag information is information regarding the relationship between a work data item and the other work data items registered in the management table, and the informing unit 24 is configured to inform at least one of a user and an administrator of the attention-flag information.

Note that, in the case where work data is data that represents the original work of a non-electronic work (e.g., document data or image data), an original-work created date or an original-work created date and time of the original work may be registered in the management table.

When work data is stored in the work storage unit, the management unit 20 registers the attribute information of this work data into the management table.

When first work data that is a new management target is attempted to be stored into the work storage unit, the determination unit 22 compares the attribute information items of work data items registered in the management table and the attribute information of the first work data and determines whether to permit the first work data to be stored into the work storage unit.

In the case illustrated in FIG. 4, as an example, when no work data that has content the same as the content of first work data that is a new management target is stored in the work storage unit, the determination unit 22 permits the first work data to be stored into the work storage unit. When work data that has content the same as the content of work data that is a new management target has already been stored in the work storage unit, the determination unit 22 does not permit the first work data to be stored into the work storage unit. When work data having content that is different from but similar to the content of first work data that is a new management target is stored in the work storage unit, the determination unit 22 permits the first work data to be stored into the work storage unit.

In the management table, the attribute information items of work data items are chronologically registered in the order in which the work data items are stored in the work storage unit. A work data item whose management number is “1” is the work data item that is stored first in the work storage unit, and the management number “2” and the subsequent management numbers are associated with the attribute information items of the other work data items in the order in which the other work data items are stored in the work storage unit.

The contents of the work data items illustrated in FIG. 4 are different form the contents of other work data items. Thus, these work data items are stored in the work storage unit, and the attribute information items of these work data items are registered in the management table. In this case, when a work data item that has content similar to the content of one of the work data items that have already been stored in the work storage unit is newly stored in the work storage unit, the determination unit 22 may register information that indicates the similarity between these work data items and attention-flag information into the management table. For example, the content of a work data item whose management number is “1” and the content of a work data item whose management number is “5” are similar to each other, and thus, information that indicates this similarity is registered into the management table while being associated with the attribute information of the work data item whose management number is “1” and the attribute information of the work data item whose management number is “5”. In addition, when the work data item whose management number is “5” is attempted to be stored into the work storage unit, the attention-flag information that indicates that a work data item (here, the work data item whose management number is “1”) that has content similar to the content of the work data item whose management number is “5” has already been stored in the work storage unit may be transmitted from the information processing apparatus 10 to the terminal apparatus 12 and may be displayed on the terminal apparatus 12.

When work data having content that is different from but similar to the content of first work data that is a new management target is stored in the work storage unit, the determination unit 22 may not permit the first work data to be stored into the work storage unit. In this case, the attribute information of the work data that is not permitted to be stored into the work storage unit may be registered in the management table. In other words, the attribute information of the work data that has been attempted to be stored into the work storage unit but actually has not been stored in the work storage unit may also be registered in the management table.

For example, the content of a work data item whose management number is “6” is similar to the content of a work data item whose management number is “4”. The work data item whose management number is “4” has been stored in the work storage unit before the work data item whose management number is “6” has been stored in the work storage unit. In addition, the created date of the work data item whose management number is “4” is earlier than the created date of the work data item whose management number is “6”. Thus, the work data item whose management number is “6” is not permitted to be stored into the work storage unit. In this case, the attention-flag information indicating that a work data item that has content similar to the content of the work data item that is attempted to be stored into the work storage unit has already been stored in the work storage unit is transmitted from the information processing apparatus 10 to the terminal apparatus 12 that is used by a user who attempts to store the work data item whose management number is “6” into the work storage unit, and the attention-flag information is displayed on the terminal apparatus 12. In this case, the work data item whose management number is “6” is not permitted to be stored into the work storage unit. For example, the work data item whose management number is “6” is not permitted to be uploaded to the work storage unit, and accordingly, uploading of this work data item is not performed. Also in this case, the attribute information of the work data item whose management number is “6” may be registered into the management table.

The content of the work data item whose management number is “5” is similar to the content of the work data item whose management number is “1”. The work data item whose management number is “1” has been stored in the work storage unit before the work data item whose management number is “5” has been stored in the work storage unit. The created date of the work data item whose management number is “5” is earlier than the created date of the work data item whose management number is “1”. Thus, the work data item whose management number is “5” is presumed to be the original work data, and the work data item whose management number is “5” is permitted to be stored into the work storage unit. For example, the work data item whose management number is “5” is permitted to be uploaded to the work storage unit. A work data item that has been stored in the work storage unit after another work data item has been stored in the work storage unit has been created before the other work data item has been created. In this case, the informing unit 24 transmits information that indicates this situation to the terminal apparatus 12 that is used by a user who has stored the work data item whose management number is “1” into the work storage unit. The information indicating this situation is displayed on the terminal apparatus 12. The informing unit 24 may transmit the information indicating this situation to a device that is used by an administrator.

When the controller 26 receives, from a user who has stored the work data item whose management number is “1” into the work storage unit or an administrator, an instruction to delete the work data item whose management number is “1”, the controller 26 may delete the work data item whose management number is “1” from the work storage unit. The controller 26 may delete the work data item whose management number is “1” from the work storage unit without receiving the deletion instruction.

Note that the management unit 20 may delete, from the management table, the attribute information of work data that has been deleted from the work storage unit or may not delete the attribute information from the management table. In the case where the attribute information is not deleted from the management table, the determination unit 22 is capable of determining whether to permit first work data that is a new management target to be stored into the work storage unit while the work data that has been stored in the work storage unit in the past and then deleted from the work storage unit is also treated as a comparison target.

The flow of processing that is performed when work data is stored into the work storage unit will be described below. Here, as an example, a user uses the terminal apparatus 12 and stores work data that has been stored in the terminal apparatus 12 into the work storage unit included in the information processing apparatus 10.

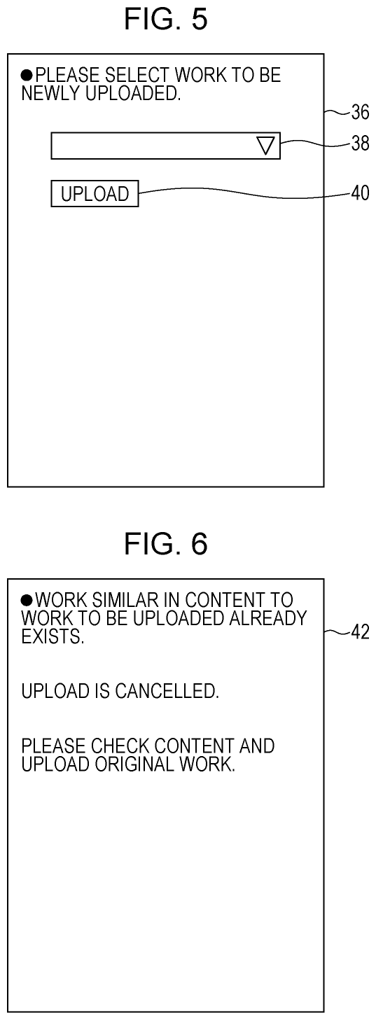

When the user operates the UI unit 30 and issues an instruction to run a program for uploading work data to the work storage unit, the controller 34 runs the program so as to cause the display unit of the UI unit 30 to display an upload screen 36 as illustrated in FIG. 5. An input field 38 and an upload button 40 are displayed on the screen 36. The input field 38 is a field in which the name of work data that is to be uploaded or information (e.g., a pass or the like) that indicates the location where the work data is stored is to be input. The user operates the UI unit 30 and inputs the name or the pass of the first work data, which is a target work data the user wants to upload, into the input field 38. As a result, the first work data is specified by the user. When the user presses the upload button 40, the controller 34 transmits the attribute information of the first work data to the information processing apparatus 10. The first work data is an example of work data that is a new management target.

When the attribute information of the first work data is transmitted from the terminal apparatus 12 to the information processing apparatus 10, the reception unit 18 receives this attribute information.

The determination unit 22 determines whether to permit the first work data to be stored into the work storage unit on the basis of the attribute information of the first work data and the attribute information registered in the management table. In other words, the determination unit 22 determines whether to permit the first work data to be uploaded to the work storage unit.

When uploading of the work data is permitted, the uploading process proceeds. For example, information that indicates the upload permission is transmitted from the information processing apparatus 10 to the terminal apparatus 12 and is displayed on the display unit of the UI unit 30. When the user operates the UI unit 30 and issues an instruction to continue the uploading process, the first work data is transmitted from the terminal apparatus 12 to the information processing apparatus 10 and stored into the work storage unit included in the information processing apparatus 10. When the uploading is permitted, the first work data may be transmitted from the terminal apparatus 12 to the information processing apparatus 10 and may be stored into the work storage unit without an instruction from the user. In addition, the management unit 20 registers the attribute information of the work data, which has been newly uploaded, to the management table.

When the uploading is not permitted, information indicating that the uploading is not permitted is transmitted from the information processing apparatus 10 to the terminal apparatus 12 and displayed on the display unit of the UI unit 30. Here, as an example, the uploading is not permitted because another work data that has content similar to the content of the first work data has already been stored in the work storage unit. In this case, for example, a screen 42 that is illustrated in FIG. 6 is displayed on the display unit of the UI unit 30. Information indicating that the other work data that has content similar to the content of the first work data has already been stored in the work storage unit is displayed on the screen 42. In addition, information indicating that the uploading is cancelled is displayed.

When the uploading is not permitted, the controller 34 does not upload the first work data to the work storage unit even if the user operates the UI unit 30 and issues an instruction to continue the uploading of the first work data. As another example, even if the first work data is transmitted to the information processing apparatus 10, the reception unit 18 may cancel the uploading without receiving the work data.

Work data that has been uploaded to the work storage unit may be used in a device, such as a PC or a smartphone, or another device (e.g., a multifunction machine). For example, work data that is to be printed may be uploaded to the work storage unit, and the work data may be downloaded by a multifunction machine from the work storage unit and may be printed by the multifunction machine. In addition, the work data may be downloaded by a PC, and a user may view the work data by using the PC. The way in which work data is used is not limited to those mentioned above, and work data may be used in a way according to the type of the work data.

As an example, the functions of the units included in the information processing apparatus 10 and the terminal apparatus 12, which have been described above, are each implemented as a result of hardware and software cooperating with each other. More specifically, the information processing apparatus 10 and the terminal apparatus 12 each include one or more processors including a CPU (not illustrated). As a result of the one or more processors reading and running a program stored in a storage device (not illustrated), each of the functions of the units included in the information processing apparatus 10 and the terminal apparatus 12 is implemented. The above-mentioned program is stored into the storage device via a recording medium such as a CD or a DVD or via a communication path such as a network. As another example, each of the functions of the units included in the information processing apparatus 10 and the terminal apparatus 12 may be implemented by, for example, a hardware resource such as a processor, an electronic circuit, or an application specific integrated circuit (ASIC). A device such as a memory may be used for the implementation. As another example, each of the functions of the units included in the information processing apparatus 10 and the terminal apparatus 12 may be implemented by digital signal processing (DSP), a field programmable gate array (FPGA), or the like.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a management unit that manages a stored work in a storage unit and a created date of the stored work in the storage unit; and
a determination unit that determines, in response to an attempt to store a first work into the storage unit, whether to allow the first work to be stored into the storage unit on a basis of comparison between a content of the stored work and a content of the first work and comparison between the created date of the stored work and a created date of the first work.

2. The information processing apparatus according to claim 1, further comprising:
a control unit that causes a terminal apparatus that is used by a user who has made the attempt to store the first work into the storage unit to display a determination result obtained by the determination unit.

3. The information processing apparatus according to claim 1,
wherein, if the storage unit has a stored work that has a content the same as or similar to the content of the first work, the determination unit further determines, between the first work and the stored work that has the content the same as or similar to the content of the first work, an original work that has an earlier created date.

4. The information processing apparatus according to claim 2,
wherein, if the storage unit has a stored work that has a content the same as or similar to the content of the first work, the determination unit further determines, between the first work and the stored work that has the content the same as or similar to the content of the first work, an original work that has an earlier created date.

5. The information processing apparatus according to claim 1,
wherein, if a content of a work is updated, an updated determination is made based on the updated content.

6. The information processing apparatus according to claim 2,
wherein, if a content of a work is updated, an updated determination is made based on the updated content.

7. The information processing apparatus according to claim 3,
wherein, if a content of a work is updated, an updated determination is made based on the updated content.

8. The information processing apparatus according to claim 4,
wherein, if a content of a work is updated, an updated determination is made based on the updated content.

9. The information processing apparatus according to claim 1,
wherein, when a created date of a work is unknown, the determination unit performs the determination processing on a basis of a last updated date of the work.

10. The information processing apparatus according to claim 2,
wherein, when a created date of a work is unknown, the determination unit performs the determination processing on a basis of a last updated date of the work.

11. The information processing apparatus according to claim 3,
wherein, when a created date of a work is unknown, the determination unit performs the determination processing on a basis of a last updated date of the work.

12. The information processing apparatus according to claim 4,
wherein, when a created date of a work is unknown, the determination unit performs the determination processing on a basis of a last updated date of the work.

13. The information processing apparatus according to claim 5,
wherein, when a created date of a work is unknown, the determination unit performs the determination processing on a basis of a last updated date of the work.

14. The information processing apparatus according to claim 6,
wherein, when a created date of a work is unknown, the determination unit performs the determination processing on a basis of a last updated date of the work.

15. The information processing apparatus according to claim 7,
wherein, when a created date of a work is unknown, the determination unit performs the determination processing on a basis of a last updated date of the work.

16. The information processing apparatus according to claim 8,
wherein, when a created date of a work is unknown, the determination unit performs the determination processing on a basis of a last updated date of the work.

17. The information processing apparatus according to claim 1, further comprising:
an informing unit that, if the storage unit has a stored work that has a content the same as or similar to the content of the first work, informs at least (i) a user who has stored the stored work that has the content the same as or similar to the content of the first work or (ii) an administrator.

18. The information processing apparatus according to claim 17,
wherein, if an author of the first work and an author of the stored work that has the content the same as or similar to the content of the first work are substantially the same, the informing unit does not perform the informing processing.

19. A non-transitory computer readable medium storing a program causing a computer to execute a process, the process comprising:
managing a stored work in a storage unit and a created date of the stored work in the storage unit; and
determining, in response to an attempt to store a first work into the storage unit, whether to allow the first work to be stored into the storage unit on a basis of comparison between a content of the stored work and a content of the first work and comparison between the created date of the stored work and a created date of the first work.
